(19) United States
(12) Patent Application Publication
(10) Pub. No.: US 2007/0161393 A1
(43) Pub. Date: Jul. 12, 2007

(54) Method and a system for talk burst control and an moderator terminal therefor

(76) Inventors: Xugang Wu, Shenzhen (CN); Zheng Wang, Shenzhen (CN); Shengting Zhang, Shenzhen (CN)

Correspondence Address: LADAS & PARRY, 5670 WILSHIRE BOULEVARD, SUITE 2100, LOS ANGELES, CA, 90036-5679, US

(21) Appl. No.: 11/607,814

(22) Filed: Dec. 1, 2006

(30) Foreign Application Priority Data
Dec. 1, 2005 (CN) 200510125720.1

(51) Int. Cl. H04B 7/00; H04Q 7/20

(52) U.S. Cl. 455/521; 455/518

(57) ABSTRACT

A method and a system for talk burst control in wireless PoC in the field of group talk technology and a moderator terminal therefore, wherein the method comprises: determining, by a moderator terminal, a talk burst sequence and delivering a talk burst dispatch message to a PoC server; dispatching, by the PoC server, the talk burst to a user terminal according to the talk burst dispatch message. According to the method and the system of the invention, the operation on talk burst control will be more flexible and the requirements of a scheduling system will be met more satisfactorily.

### FIELD OF THE INVENTION

The present invention relates to the field of group session technology, and in particular, to a method and a system for talk burst control in wireless PoC (Push to talk over Cellular) and a moderator terminal therefore.

### BACKGROUND OF THE INVENTION

PoC is a semi-duplex data service in a cellular network for 1-1 or 1-M group session. In one and the same session, for a type of media, only one participant has the right to deliver this type of media. For a speech flow, control on the right to deliver such media is referred to as talk burst control.

In the existing standard, groups include temporary group, chat group and predefined group. Chat group and predefined group are predefined in an XDM (XML Document Management) server; a user may initiate a session by using a group ID in a request, and a server may obtain the information of the group members from the XDM server based on the group ID. Temporary group is not defined in the XDM server; a user who initiates a session may include a list of users to be invited in a session request message. The XDM server is an XML (extensible Markup Language) Document Management server for storing XML documents. A PoC group may be defined in an XML file in the XDM server. A PoC server has the right to obtain XML documents from the XDM server.

In the conventional operation, talk burst control is realized by means of push-to-control, that is, when a user receives a talk burst idle indication, the user races to control the talk burst, and the user who first controls the talk burst will get the talk burst.

As the technology develops, a queue mechanism appears in talk burst control, that is, during the speech of a user, other users may apply for the talk burst, and the server will control the talk burst according to the priority and time of a talk burst request. As a result, user experience will be improved.

In some practical scheduling systems, a dispatcher need to know conditions of the members at any moment. In some cases, the members are required to report even if they do not deliver a request; or when an emergency needs to be reported or treated, a corresponding user is required to speak at once upon requests of the members. However, the conventional push-to-control or queue mechanisms cannot realize this kind of function.

### SUMMARY OF THE INVENTION

A method and a system for talk burst control and a moderator terminal therefore are provided according to the embodiments of the present invention. In the embodiments, the moderator terminal performs talk burst control and dispatches a talk burst message to a PoC server, and the PoC server notifies a user terminal of the dispatched message, so that the operation on talk burst control may be more flexible and the requirements of a scheduling system will be met more satisfactorily.

The technical solution provided according to the embodiments of present invention may be as follows:

A system for talk burst control includes: a moderator terminal, determining a talk burst sequence and delivering a talk burst dispatch message carrying talk burst dispatch to a PoC server; the PoC server, notifying a user terminal to start a session according to the talk burst dispatch message.

In the system for talk burst control:

the moderator terminal is further used to modify the talk burst dispatch and deliver a message carrying the talk burst dispatch modified by the moderator terminal to the PoC server, and

the PoC server saves the talk burst dispatch according to the message carrying the talk burst dispatch modified by the moderator terminal.

In the system for talk burst control:

the PoC server is further used to delete a talk burst of a user terminal which is talking and deliver a talk burst occupying message carrying a user identifier of the user terminal which is talking to the moderator terminal;

the moderator terminal is further used to generate a talk burst queue and delete an item corresponding to the user identifier of the user terminal which is talking in the talk burst occupying message from the talk burst queue.

In the system for talk burst control:

the user terminal is used to deliver a session request to the PoC server, and the session request carries a URI list of user terminals which may serve as a moderator;

the PoC server determines a moderator terminal according to the session request and notifies the moderator terminal determined by the PoC server.

In the system for talk burst control:

the PoC server is further used to receive a talk burst request from the user terminal and forward the talk burst request to the moderator terminal;

the moderator terminal saves the talk burst request and dispatch a talk burst according to the talk burst request forwarded by the PoC server.

The system for talk burst control further includes a moderator terminal which may serve as a moderator, wherein

the moderator terminal is further used to deliver a moderator negotiation request carrying an identifier of a moderator terminal which may serve as a moderator to the PoC server;

the PoC server further delivers the moderator negotiation request to the moderator terminal which may serve as a moderator according to the identifier of a moderator terminal which may serve as a moderator in the moderator negotiation request;

the moderator terminal which may serve as a moderator responds to accept the moderator negotiation request.

A method for talk burst control includes:

determining, by a moderator terminal, a talk burst sequence and delivering a talk burst dispatch message to a PoC server;

dispatching, by the PoC server, the talk burst to a user terminal according to the talk burst dispatch message.

The method for talk burst control further includes:

delivering, by the user terminal, a session request as a moderator to the PoC server;

determining, by the PoC server, a moderator terminal according to the session request and notifying the moderator terminal determined by the PoC server.

The method for talk burst control further includes:

receiving, by the PoC server, a talk burst request and forwarding the talk burst request to the moderator terminal;

saving, by the moderator terminal, the talk burst request and dispatching a talk burst according to the talk burst request.

In the method for talk burst control, the moderator terminal stores a certain strategy and the process of determining, by the moderator terminal, the talk burst sequence and delivering the talk burst dispatch message to the PoC server includes:

generating, by the moderator terminal, a talk burst queue according to the certain strategy;

delivering, by the moderator terminal, a talk burst dispatch message carrying the talk burst queue generated by the moderator terminal to the PoC server;

saving, by the PoC server, the talk burst queue according to the talk burst dispatch message.

The method for talk burst control further includes:

modifying, by the moderator terminal, the talk burst queue generated by the moderator terminal and delivering a talk burst dispatch maintenance message carrying the talk burst queue modified by the moderator terminal to the PoC server, and

modifying, by the PoC server, the talk burst queue saved in the PoC server according to the talk burst queue modified by the moderator terminal in the talk burst dispatch maintenance message.

The method for talk burst control further includes:

regenerating, by the moderator terminal, another talk burst queue and delivering, the another talk burst queue regenerated by the moderator terminal in the talk burst dispatch maintenance message to the PoC server,

replacing, by the PoC server, the talk burst queue saved by the PoC server with the another talk burst queue regenerated by the moderator terminal in the talk burst dispatch maintenance message.

The method for talk burst control further includes:

deleting, by the PoC server, an item corresponding to a talk burst of a user terminal which is talking from the talk burst queue save by the PoC server, and delivering a talk burst occupying message carrying a user identifier of the user terminal which is talking to the moderator terminal;

deleting, by the moderator terminal, an item corresponding to the user identifier in the talk burst occupying message from the talk burst queue.

In the method for talk burst control, the talk burst dispatch message of talk burst dispatch delivered to the PoC server includes a talk burst queue and the method further includes:

saving, by the PoC server, the talk burst queue in the talk burst dispatch message;

deleting, by the PoC server, an item corresponding to the talk burst dispatch from the talk burst queue saved in the PoC server.

The method for talk burst control further includes:

receiving, by the PoC server, a talk burst request from a user terminal delivering the talk burst request and forwarding the talk burst request to the moderator terminal;

dispatching, by the moderator terminal, a talk burst to the PoC server according to the talk burst request forwarded by the PoC server.

The method for talk burst control further includes:

receiving, by the PoC server, a talk burst cancel request from the user terminal delivering the talk burst request;

if the PoC server saves the talk burst queue and the talk burst of the user terminal delivering the talk burst request has already been in the queue, the PoC server deleting the talk burst of the user terminal delivering the talk burst request from the talk burst queue saved by the PoC server and delivering a cancel confirmation message to the user terminal delivering the talk burst request; otherwise, forwarding, by the PoC server, the talk burst cancel request from the user terminal delivering the talk burst request to the moderator terminal,

deleting, by the moderator terminal, the talk burst of the user terminal delivering the talk burst request from a talk burst queue generated by the moderator terminal or deleting the talk burst request of the user terminal delivering the talk burst request from user talk burst requests saved in the moderator terminal and returning a cancel confirmation message to the user terminal delivering the talk burst request.

The method for talk burst control further includes:

delivering, by the PoC server, a talk burst cancel request to the moderator terminal and recording processing status of the talk burst cancel request, and filtering out the user terminal before receiving final processing status of the talk burst cancel request from the moderator terminal if the user terminal is included in a new dispatch.

The method for talk burst control further includes:

delivering, by the moderator terminal, a moderator negotiation request carrying an identifier of another moderator terminal which may serve as a moderator r;

delivering, by the PoC server, the moderator negotiation request to the another moderator terminal which may serve as a moderator;

responding, by the another moderator terminal which may serve as a moderator, a moderator negotiation request acceptance message to the moderator.

A moderator terminal, determining a talk burst sequence, generating a talk burst queue and delivering a talk burst dispatch message carrying the talk burst queue to a PoC server.

The moderator terminal includes:

a talk burst queue determination module, determining the talk burst sequence, generating a talk burst queue and delivering the talk burst dispatch message carrying the talk burst queue to the PoC server;

a talk burst queue maintenance module, updating the talk burst queue an and delivering a talk burst dispatch maintenance message to the PoC server.

The moderator terminal further includes: a talk burst request storage module, saving talk burst requests delivered by the PoC server and providing a data source to the talk burst queue determination module.

As can be seen from the above technical solutions according to the embodiments of the present invention, a moderator terminal generates a talk burst queue and dispatches a talk burst to a PoC server, and the PoC server dispatches the talk burst to a designated user, so that the operation on talk burst control may be more flexible, and the requirements of a scheduling system will be met more satisfactorily.

### BRIEF DESCRIPTION OF THE DRAWINGS

FIG. 1 shows a schematic diagram of a system according to an embodiment of the invention;

FIG. 2 shows a flow chart of a method according to an embodiment of the invention;

FIG. 3 shows a flow chart of a method according to another embodiment of the invention; and

FIG. 4 shows a flow chart of a method for switching moderators according to an embodiment of the invention.

### DETAILED DESCRIPTION OF THE EMBODIMENTS

An embodiment of the present invention provides a method and a system for talk burst control and introduces a moderator terminal. A talk burst is dispatched to a PoC server via the moderator terminal, and the PoC server notifies a user to speak, so that the operation on talk burst control may be more flexible and the requirements of a scheduling system will be met more satisfactorily.

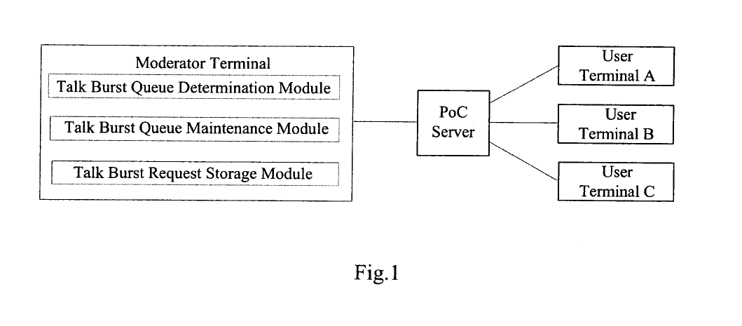

An embodiment of the present invention provides a system for talk burst control, the architecture of which is shown in FIG. 1, including a moderator terminal, a PoC server and multiple user terminals.

The moderator terminal includes multiple functional modules for realizing talk burst control, i.e., a talk burst queue determination module, a talk burst queue maintenance module and a talk burst request storage module.

The talk burst queue determination module is used for determining a talk burst sequence according to user talk burst requests saved in the talk burst request storage module, automatically determining a talk burst queue according to a certain strategy and delivering a talk burst dispatch message to the PoC server;

The talk burst queue maintenance module is used for updating a talk burst queue, delivering a talk burst dispatch maintenance message to the PoC server, and synchronizing with a talk burst queue message in the PoC server;

The talk burst request storage module is used for saving user talk burst requests and providing a data source for the talk burst determination module.

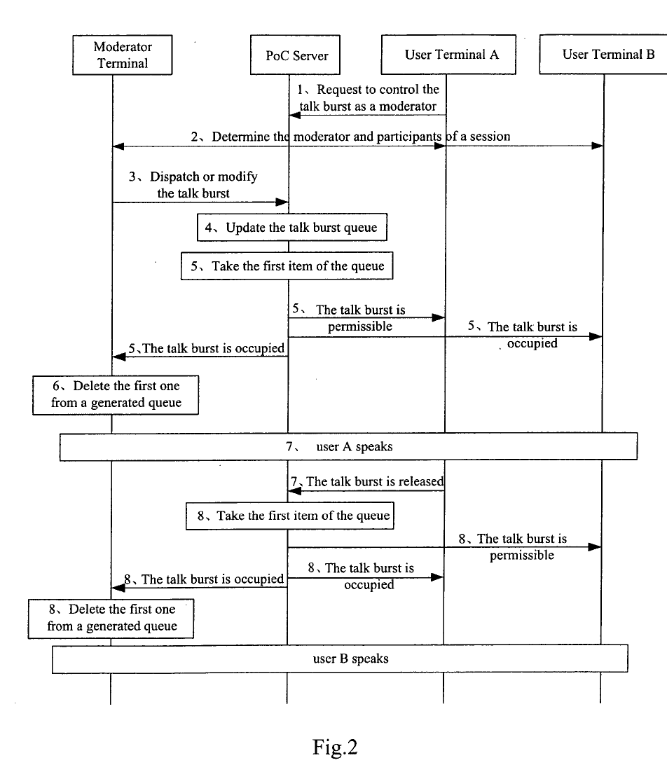

An embodiment of the present invention provides a method for talk burst control. FIG. 2 depicts an operation flow of one of its embodiments, This diagram is merely an example, which should not unduly limit the scope of the claims. One of ordinary skill in the art would recognize many variations, alternatives, and modifications. As shown in FIG. 2, the method includes the following processes:

Process 1: User terminal A delivers a session request to the PoC server indicating to establish a session to be controlled by a moderator terminal

User terminal A may designate the session to control talk burst by a moderator in the field Request-URI (Request Uniform Resource Identifier) of the session request by expanding an invite/refer request in the calling flow of a PoC standard of OMA (Open Mobile Alliance), and the session request may contain a URI list of members, and the PoC server will save the URI list of user terminals which may serve as a moderator;

For example, the value of the field Request-URI in the session request may be set as sip (Session Initiation Protocol): OMA-Golfbuddies@networkX.net; session=chat; floor-control=moderate; floor-control=moderate indicates that the talk burst control of a session will be controlled by a moderator; or the session to be controlled by a moderator will be regarded as a group session, at this point, the value of a corresponding field Request-URI is sip: OMA-Golfbuddies@networkX.net; session=moderate.

Process 2: the PoC server determines the moderator and the participants in this session;

First, determine whether the user terminal, which sends the session request, is a moderator; the determining method includes: obtaining moderator information defined by a group from an XDM server, or obtaining a moderator list from a request of a temporary group session; checking whether the user terminal is within the moderator list; if the user terminal is a moderator, invite all the invitees to participate in the session; if the user terminal is not a moderator, invite all moderators and take the moderator who sends a reply first as the moderator of the session and notify the moderator who sends the reply first, and then invite other invitees who are not moderators to participate in the session (the process for obtaining the invitees is not restricted in the invention); in the embodiment shown in FIG. 2, user terminal A which delivers a session request is not a moderator;

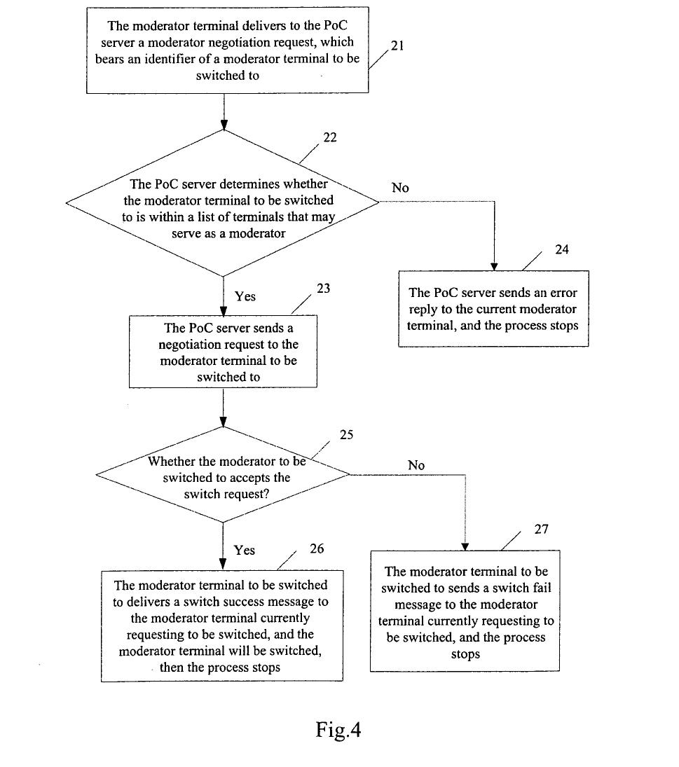

During the process of moderator talk burst control, there may occur a moderator switch operation, which will be described in detail in connection with FIG. 4.

Process 3: The moderator terminal generates the talk burst queue and delivers the talk burst dispatch message or the talk burst dispatch maintenance message to the PoC server;

The moderator terminal stores a certain strategy to determine a talk burst sequence. The talk burst queue determination module of the moderator terminal automatically determines the talk burst sequence according to the certain strategy or the moderator manually determines the talk burst sequence, and generates the talk burst queue for storing the result of talk burst sequence determined by the moderator terminal. The certain strategy for automatic determination may be selected as required; for example, the talk burst sequence may be determined according to the certain strategy of “first request first access” and be stored in the moderator terminal;

The talk burst dispatch message delivered to the PoC server by the moderator terminal carries the talk burst queue generated by the moderator terminal, which includes information of one or more users;

When the moderator terminal needs to modify the talk burst queue, the talk burst queue maintenance module delivers the talk burst dispatch maintenance message; the talk burst dispatch maintenance message includes: deleting one or more users from a talk burst queue generated by the moderator terminal, modifying the locations of one or more users in the talk burst queue generated by the moderator terminal, or adding one or more users in the talk burst queue generated by the moderator terminal;

If one or more users need to be deleted from the talk burst queue generated by the moderator terminal, the talk burst dispatch maintenance message will contain a delete list, which includes information of the one or more users to be deleted;

If information of one or more users needs to be modified, the talk burst dispatch maintenance message will contain a talk burst location of the one or more users in the talk burst queue;

If one or more users need to be added, the talk burst dispatch maintenance message will contain an add list, which indicates the talk burst location of the one or more users in the queue;

The location may be a relative location, i.e., a location with respect to the talk burst of another user; the location may also be an absolute location, i.e., the location of the user in the queue;

If the content the moderator terminal maintains is larger, deliver the talk burst dispatch maintenance message which carries another talk burst queue re-generated by the moderator terminal to the PoC server and instruct the PoC server to replace the talk burst queue saved by the PoC server with the another talk burst queue re-generated by the moderator terminal and carried in the talk burst dispatch maintenance message.

Process 4: the PoC server updates the talk burst queue saved by the PoC server:

Upon receiving the talk burst dispatch message or the talk burst dispatch maintenance message from the moderator terminal, if the talk burst queue in the talk burst dispatch message received by the PoC server does not exist, the PoC server stores the talk burst queue in the talk burst dispatch message according to the talk burst dispatch message; if the talk burst queue in the talk burst dispatch message already exists in the PoC server, the PoC server updates the talk burst queue and keeps the talk burst queue synchronized with the talk burst queue of the moderator terminal:

Process 5: the PoC server notifies user terminal A to start a session according to the talk burst queue stored in the PoC server and updates the talk burst queue according to the talk burst dispatch;

The PoC server takes the first item, i.e., a item which has the highest priority, from the talk burst queue saved in the PoC server and notifies the user terminal corresponding to the first item, e.g. user terminal A shown in FIG. 2 to start a session, and informs other user terminals, such as user terminal B and the moderator terminal, that the talk burst is occupied and that they should be ready for receiving the session; upon the PoC server notifies the user terminal to start the session, the PoC server updates the talk burst queue of the session, that is, the PoC server deletes the item corresponding to user terminal starting the session from the talk burst queue saved in the PoC server;

Process 6: the moderator terminal deletes the user of speaking;

Upon the moderator terminal receives a talk burst occupying message, the talk burst queue maintenance module determines whether the user terminal starting the session corresponds to an item in the talk burst queue according to a user identifier in the talk burst occupying message; if they are the same, delete the item;

Process 7: after speaking, user terminal A releases the talk burst;

Upon receiving a talk burst, user terminal A starts a session; after the session completes, user terminal A sends a talk burst release message to the PoC server and releases the talk burst;

Process 8: the PoC server selects another item from the talk burst queue saved by the PoC server and dispatches a talk burst for another user terminal corresponding to the another item to start another session;

This dispatch operation is the same as Process 3.

The above operation flow is a flow of the moderator terminal dispatching the talk burst under the circumstances that the user terminal does not send a talk burst request. Upon the user terminal sends a talk burst request to the PoC server, the PoC server delivers the talk burst request to the moderator terminal. The talk burst request delivered by the user terminal carries a user identifier and/or a request description, such as an emergency report, etc. Upon the talk burst request is received by the moderator terminal, the talk burst request will be saved in the talk burst request storage module. The talk burst queue determination module dispatches a talk burst according to the talk burst request.

Upon a user terminal delivering a talk burst request delivers the talk burst request, the user terminal delivering the talk burst request may cancel the talk burst request. The process of cancelling the talk burst request is as follows. The user terminal delivering a talk burst request delivers a talk burst cancel request to the PoC server. Upon the PoC server receives the talk burst cancel request, the PoC server deletes the talk burst of the user terminal delivering a talk burst request from the talk burst queue saved by the PoC server and delivering a cancel confirmation message to the user terminal delivering the talk burst request if the PoC server stores the talk burst queue and the user terminal delivering the talk burst request has already been in the talk burst queue saved by the PoC server; otherwise, the PoC server forwards the talk burst cancel request from the user terminal delivering the talk burst request to the moderator terminal and records the processing status of the talk burst cancel request. Before receiving a final processing status of the talk burst cancel request delivered by the moderator terminal, if a new dispatch carries the user, filter out the user. Upon receiving the talk burst cancel request, the moderator terminal deletes the talk burst of the user terminal from the talk burst queue generated by the moderator terminal or deletes the talk burst request from the talk burst requests stored in the talk burst request storage module and returns a cancel request confirmation message to the user terminal delivering the talk burst request and terminates the process of cancelling a talk burst.

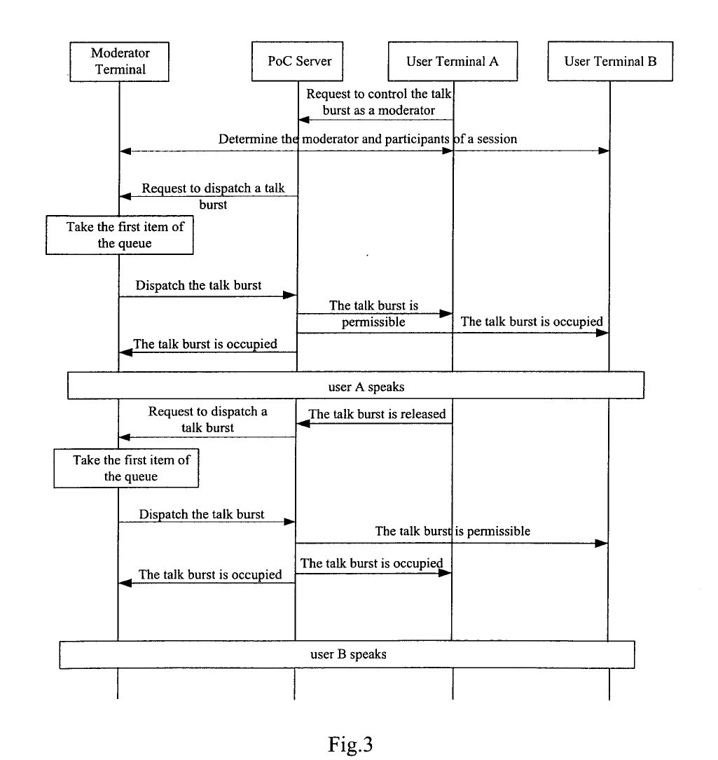

The above operation flow corresponds to the case where both the moderator terminal and the PoC server have saved talk burst queues respectively. When the PoC server does not have the talk burst queue, the operation flow is shown in FIG. 3. The operation flow differs from the above flow in that the moderator terminal has a talk burst queue, and when dispatching a talk burst, the moderator terminal is first requested by the PoC server to dispatch a talk burst; if the talk burst queue in the moderator terminal is null, the moderator terminal returns a talk burst idle message to the PoC server; otherwise, the moderator terminal selects the first item (i.e., an item having the highest priority) from the talk burst queue and delivers the first item to the PoC server; the PoC server notifies the user terminal corresponding to the first item of the dispatched message; the user terminal receiving the dispatched message starts a session and releases the talk burst; then the above dispatch operation is repeated.

Each process of the talk burst dispatch operation also may be performed at the same time.

FIG. 4 depicts a flow chart of a method for switching moderator according to an embodiment of the invention, This flow chart is merely an example, which should not unduly limit the scope of the claims. One of ordinary skill in the art would recognize many variations, alternatives, and modifications. As shown in FIG. 4, the process includes:

Process 21: the moderator terminal delivers a moderator negotiation request to the PoC server and the moderator negotiation request carries an identifier of another moderator terminal which may serve as a moderator; if the talk burst queue and/or a talk burst request queue exist on the moderator terminal delivering the moderator negotiation request, the talk burst queue and/or the talk burst request queue are also contained in the moderator negotiation request;

Process 22: the PoC server determines whether the another moderator terminal corresponding to the identifier of the another moderator terminal which may serve as a moderator in the moderator negotiation request is within the URI list of user terminals which may serve as a moderator; if Yes, perform process 23; if No, perform process 23;

Process 23: the PoC server delivers a negotiation request to the another moderator terminal which may serve as a moderator;

Process 24: the PoC server delivers an error reply to the moderator terminal delivering the moderator negotiation request, and terminates the process;

Process 25: the another moderator terminal which may serve as a moderator receives the negotiation request from the PoC server and responds whether it accepts the moderator negotiation request; if Yes, perform process 26; if No, perform process 27;

Process 26: the another moderator terminal which may serve as a moderator responds a moderator negotiation request acceptance message to the moderator terminal delivering the moderator negotiation request and the moderator terminal will be switched, and the process is terminated;

Process 27: the another moderator terminal which may serve as a moderator delivers a moderator negotiation request non-acceptance message to the moderator terminal delivering the moderator negotiation request and the process is terminated.

In the moderator switch process, if the talk burst request is received by the moderator terminal delivering the moderator negotiation request, the moderator terminal returns a request fail message to the user terminal delivering the talk burst request.

Accordingly, in the embodiments of the invention, talk burst control is realized via a moderator terminal. The moderator terminal generates a talk burst queue in advance and updates the talk burst queue in real time. A PoC server dispatches the talk burst according to the talk burst queue. As a result, the talk burst dispatch operation will be much easier and more convenient.

What is described above relates merely to the preferred embodiments of the invention. However, the protection scope of the invention is not limited thereto. Within the technical disclosure of the invention, additional changes and modifications which readily occur to those skilled in the art will fall within the protection scope of the invention. Therefore, the protection scope of the invention is defined by the appended claims and their equivalents.

What is claimed is:

1. A system for talk burst control, comprising:
a moderator terminal, determining a talk burst sequence and delivering a talk burst dispatch message carrying talk burst dispatch to a PoC server;
the PoC server, notifying a user terminal to start a session according to the talk burst dispatch message.

2. The system for talk burst control according to claim 1, wherein
the moderator terminal is further used to modify the talk burst dispatch and deliver a message carrying the talk burst dispatch modified by the moderator terminal to the PoC server, and
the PoC server saves the talk burst dispatch according to the message carrying the talk burst dispatch modified by the moderator terminal.

3. The system for talk burst control according to claim 1, wherein
the PoC server is further used to delete a talk burst of a user terminal which is talking and deliver a talk burst occupying message carrying a user identifier of the user terminal which is talking to the moderator terminal;
the moderator terminal is further used to generate a talk burst queue and delete an item corresponding to the user identifier of the user terminal which is talking in the talk burst occupying message from the talk burst queue.

4. The system for talk burst control according to claim 1, wherein
the user terminal is used to deliver a session request to the PoC server, and the session request carries a URI list of user terminals which may serve as a moderator;
the PoC server determines a moderator terminal according to the session request and notifies the moderator terminal determined by the PoC server.

5. The system for talk burst control according to claim 4, wherein
the PoC server is further used to receive a talk burst request from the user terminal and forward the talk burst request to the moderator terminal;
the moderator terminal saves the talk burst request and dispatch a talk burst according to the talk burst request forwarded by the PoC server.

6. The system for talk burst control according to claim 1, further comprising a moderator terminal which may serve as a moderator, wherein
the moderator terminal is further used to deliver a moderator negotiation request carrying an identifier of a moderator terminal which may serve as a moderator to the PoC server;
the PoC server further delivers the moderator negotiation request to the moderator terminal which may serve as a moderator according to the identifier of a moderator terminal which may serve as a moderator in the moderator negotiation request;
the moderator terminal which may serve as a moderator responds to accept the moderator negotiation request.

7. A method for talk burst control, comprising:
determining, by a moderator terminal, a talk burst sequence and delivering a talk burst dispatch message to a PoC server;
dispatching, by the PoC server, the talk burst to a user terminal according to the talk burst dispatch message.

8. The method for talk burst control according to claim 7, further comprising:
delivering, by the user terminal, a session request as a moderator to the PoC server;
determining, by the PoC server, a moderator terminal according to the session request and notifying the moderator terminal determined by the PoC server.

9. The method for talk burst control according to claim 8, further comprising:
receiving, by the PoC server, a talk burst request and forwarding the talk burst request to the moderator terminal;
saving, by the moderator terminal, the talk burst request and dispatching a talk burst according to the talk burst request.

10. The method for talk burst control according to claim 7, wherein the moderator terminal stores a certain strategy and the process of determining, by the moderator terminal, the talk burst sequence and delivering the talk burst dispatch message to the PoC server comprises:
generating, by the moderator terminal, a talk burst queue according to the certain strategy;
delivering, by the moderator terminal, a talk burst dispatch message carrying the talk burst queue generated by the moderator terminal to the PoC server;
saving, by the PoC server, the talk burst queue according to the talk burst dispatch message.

11. The method for talk burst control according to claim 10, further comprising:
modifying, by the moderator terminal, the talk burst queue generated by the moderator terminal and delivering a talk burst dispatch maintenance message carrying the talk burst queue modified by the moderator terminal to the PoC server; and
modifying, by the PoC server, the talk burst queue saved in the PoC server according to the talk burst queue modified by the moderator terminal in the talk burst dispatch maintenance message.

12. The method for talk burst control according to claim 10, further comprising
regenerating, by the moderator terminal, another talk burst queue and delivering, the another talk burst queue regenerated by the moderator terminal in the talk burst dispatch maintenance message to the PoC server;
replacing, by the PoC server, the talk burst queue saved by the PoC server with the another talk burst queue regenerated by the moderator terminal in the talk burst dispatch maintenance message.

13. The method for talk burst control according to claim 10, further comprising
deleting, by the PoC server, an item corresponding to a talk burst of a user terminal which is talking from the talk burst queue saved by the PoC server, and delivering a talk burst occupying message carrying a user identifier of the user terminal which is talking to the moderator terminal;
deleting, by the moderator terminal, an item corresponding to the user identifier in the talk burst occupying message from the talk burst queue.

14. The method for talk burst control according to claim 7, wherein the talk burst dispatch message of talk burst dispatch delivered to the PoC server comprises a talk burst queue and the method further comprising:
saving, by the PoC server, the talk burst queue in the talk burst dispatch message;
deleting, by the PoC server, an item corresponding to the talk burst dispatch from the talk burst queue saved in the PoC server.

15. The method for talk burst control according to claim 7, further comprising:
receiving, by the PoC server, a talk burst request from a user terminal delivering the talk burst request and forwarding the talk burst request to the moderator terminal;
dispatching, by the moderator terminal, a talk burst to the PoC server according to the talk burst request forwarded by the PoC server.

16. The method for talk burst control according to claim 15, further comprising:
receiving, by the PoC server, a talk burst cancel request from the user terminal delivering the talk burst request;
if the PoC server saves the talk burst queue and the talk burst of the user terminal delivering the talk burst request has already been in the queue, the PoC server deleting the talk burst of the user terminal delivering the talk burst request from the talk burst queue saved by the PoC server and delivering a cancel confirmation message to the user terminal delivering the talk burst request; otherwise, forwarding, by the PoC server, the talk burst cancel request from the user terminal delivering the talk burst request to the moderator terminal;
deleting, by the moderator terminal, the talk burst of the user terminal delivering the talk burst request from a talk burst queue generated by the moderator terminal or deleting the talk burst request of the user terminal delivering the talk burst request from user talk burst requests saved in the moderator terminal and returning a cancel confirmation message to the user terminal delivering the talk burst request.

17. The method for talk burst control according to claim 16, further comprising:
delivering, by the PoC server, a talk burst cancel request to the moderator terminal and recording processing status of the talk burst cancel request, and filtering out the user terminal before receiving final processing status of the talk burst cancel request from the moderator terminal if the user terminal is included in a new dispatch.

18. The method for talk burst control according to claim 7, further comprising:
delivering, by the moderator terminal, a moderator negotiation request carrying an identifier of another moderator terminal which may serve as a moderator;
delivering, by the PoC server, the moderator negotiation request to the another moderator terminal which may serve as a moderator;
responding, by the another moderator terminal which may serve as a moderator, a moderator negotiation request acceptance message to the moderator.

19. A moderator terminal, characterized in determining a talk burst sequence, generating a talk burst queue and delivering a talk burst dispatch message carrying the talk burst queue to a PoC server.

20. The moderator terminal according to claim 19, comprising:
a talk burst queue determination module, determining the talk burst sequence, generating a talk burst queue and delivering the talk burst dispatch message carrying the talk burst queue to the PoC server;
a talk burst queue maintenance module, updating the talk burst queue and delivering a talk burst dispatch maintenance message to the PoC server.

21. The moderator terminal according to claim 20, further comprising:
a talk burst request storage module, saving talk burst requests delivered by the PoC server and providing a data source to the talk burst queue determination module.
